(19) United States
(12) Patent Application Publication
(10) Pub. No.: US 2021/0086390 A1
(43) Pub. Date: Mar. 25, 2021

(54) METHOD OF CUTTING DESIGNS WITH INNER GEOMETRIES IN CNC WIRE CUTTING

(71) Applicant: VISWESH SRINIVASAN, CHENNAI (IN)

(72) Inventor: VISWESH SRINIVASAN, CHENNAI (IN)

(21) Appl. No.: 16/611,911

(22) PCT Filed: May 9, 2018
(86) PCT No.: PCT/IN2018/050289

§ 371 Date: Nov. 8, 2019

(30) Foreign Application Priority Data
May 9, 2017 (IN) 201741016238
Jun. 21, 2017 (IN) 201741021664
Aug. 13, 2017 (IN) 201743028765
Nov. 22, 2017 (IN) 201741041936
Mar. 9, 2018 (IN) 201841008647

(51) Int. Cl. B26F 3/12; B26D 3/00

(52) U.S. Cl. CPC B26F 3/12; B26D 5/005; B26D 3/006

(57) ABSTRACT

It is often required to cut designs with inner geometries in foam blocks. In traditional method of cutting with hotwire, cutting can only start from outer edge. This results in a cut line between outer and inner geometries, weakening the design. In this invention, an intelligent rigid heating tool is proposed, that can pierce the raw material in the middle, without having to start from outer edge. A latching mechanism for providing double side support for the rigid cutting tool is proposed. An automatic tool path generation method is also proposed, to prevent the tool from cutting the block, when piercing or retracting. A flexible knife is proposed in this knife, that can make the system compact. A sensor to measure deflection in the knife is also proposed in this system, to implement closed loop speed control, resulting in higher productivity.

### FIELD OF INVENTION

This invention relates to the field of CNC profile cutting. This invention proposes a special tool and cutting method, which enables to pierce and cut inner geometries in foam, metal blocks, without any bridging tool path to outer geometry. The present application is based on, and claims priority from an Indian Application Numbers 201741016238 filed on 9 May 2017, 201741021664 filed on 21 Jun 2017, 201743028765 filed on 13 Aug. 2017, 201741041936 filed on 22 Nov. 2017, 201841008647 filed on 9 Mar. 2018 and PCT/IN2018/050289 filed on 9 May 2018, the disclosure of which is hereby incorporated by reference herein.

### BACKGROUND OF INVENTION

In CNC wire cutting machines, it is often required to cut designs with inner geometries in big block of material. Various foams like EPS, EPE, XPS foams can be cut using hot wire methods. EPS is a 20 billion USD Industry with wide applications in Construction, packing, Insulation etc. etc. Hence there is a need to develop CNC machines that can cut EPS to desired shape accurately and quickly. Various metals can be cut by CNC wire EDM machines.

But in processes like CNC wire cutting, a bridging tool path to the outer geometry cannot be avoided, which weakens the manufactured design. i.e. Cutting cannot start from the middle of the block, but can only start from outside the block.

Short rigid tools are sometimes used for piercing and cutting inner geometries, but this short tool results in low productivity.

Hence there is a need to develop a new tool and cutting method, which can cut designs with inner geometries and also produce output without compromising strength of the manufactured object.

### OBJECT OF INVENTION

The principal object of this invention is to develop a cutting tool and method that can cut designs with inner geometries in foam blocks in bulk quantity.

Another objective of the invention is to develop a programmable rigid heating rod, that can be heated in multiple modes to achieve either piercing or cutting with the same tool.

Another objective is to make this block piercing system very compact.

Another objective of the invention is to develop a robust heating knife without failure modes.

Another objective of the invention is to develop an intelligent knife with sensor for deflection measurement, to get feedback of cutting forces and adjust cutting speed or current in a closed loop manner.

These and other objects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts the proposed system for cutting designs with inner geometries in big foam blocks.

FIG. 2 depicts the typical beam deflection and the proposed latching mechanism.

FIG. 3 depicts the details of the right-side support to the cutting tool.

FIG. 4 illustrates the internal details of the proposed multi-purpose cutting tool.

FIGS. 5 & 6 illustrates need for intelligent automatic method to choose the pierce point.

FIG. 7. BLOCK PIERCING AND RESTRING SYSTEM WITH FLEXIBLE KNIFE

FIG. 8. BLOCK PIERCING AND RESTRING SYSTEM CLOSEUP VIEW

FIG. 9. SHOWS FLEXIBLE KNIFE AFTER FURTHER PIERCING.

FIG. 10. SHOWS SLIT HOTKNIFE FOR EASY BENDING

FIG. 11. BLOCK PIERCING AND RESTRING SYSTEM

FIG. 12. EXISTING HOT KNIFE DESIGN

FIG. 13. PROPOSED COMPOSITE HOTKNIFE DESIGN

FIG. 14. KNIFE WITH DEFLECTION SENSOR

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. For example, it should be noted that while some embodiments are explained with respect to cutting of EPS material using Heated wire, any other application may also incorporate the subject matter of the invention with little or no modifications. Accordingly, the examples should not be construed as limiting the scope of the embodiments herein.

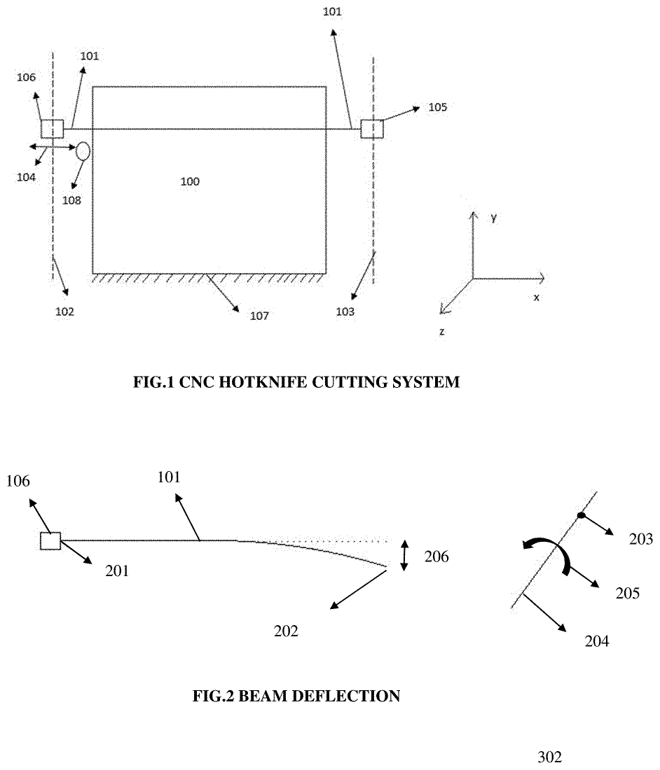

The embodiments herein describe an intelligent automated cutting method for piercing and cutting inner geometries in foam blocks, without need for a bridging tool path to outer geometry, which will render the structure weak. Referring now to the drawings, and more particularly to FIGS. 1 through 14, where similar reference characters denote corresponding features consistently throughout the figures, there are shown embodiments.

FIG. 1 shows a big block of raw material 100 resting on base 107. A heated rod/tool 101 is held on supports 105 and 106.

The tool 101 is movable on axis 104. Axis 104 is a computer controlled motion system capable of precisely controlling the position of tool 101. The tool 101 can be moved away from the material (retract) or move towards the material (piercing/plunging action) by axis 104.

While left side of 101 is always attached to support 106, the right side of 101 is detached from support 105 most of the time, except in the fully plunged position, in which the right side of 101 gets support from 105.

This lack of support from 105 results in tool 101 behaving like a cantilevered beam, with only left side support.

This cantilever mounting can result in beam deflection 206 as shown in FIG. 2.

This deflection can result in the beam bending and also in unwanted cuts on the raw material and also limits plunging speed.

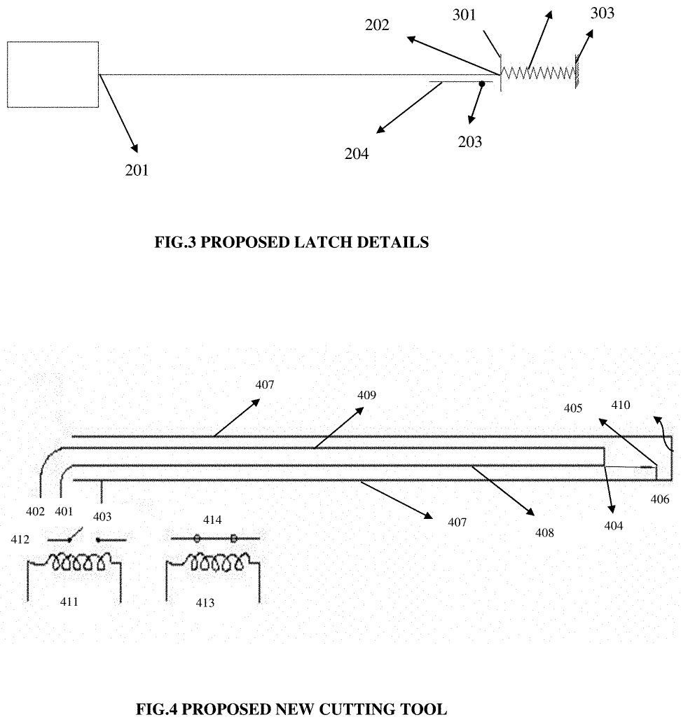

To avoid this deflection during piercing operation, a special tool design as shown in FIG. 4 is proposed.

The tool design is such that either the tip region near 410 of the tool alone can be heated or the entire body of the tool can be heated. Which portion will heat is computer controllable with help of relay/transistors (411, 413) and their NC or NO contacts 412, 414 etc.

During piercing, only the tip is heated. As the tool 101 enters the raw material, it melts the raw material and creates a hole/tunnel path. The remaining body of the tool can easily travel into the raw material via this tunnel. Since the body of the tool is not actively heated, it will not be melting the raw material. Now this raw material itself will support the self-weight of the tool 101, thus preventing deflection 206.

Once deflection is avoided/minimized by this method, the tool can plunge faster into the material, without worrying about further beam deflection.

The internal details of tool 101 is shown in FIG. 4. It consists of a thin (1-3 mm typically, but not limited to this) hollow metallic tube 407 with tip 410.

408 is a special alloy (typically NiChrome NiCr) resistance heating wire, that heats up when current is passed through it.

409 is a low resistance conducting metallic wire (typically copper) with very low Ohm/ft value compared to NiCr alloy.

One end 404 of the wire 409 is electrically connected to point 404 on the NiCr wire 408. Point 404 is near the tip of the 408 and 407.

402 is other end of this wire 409.

One of the extreme end 405 of the wire 408 is electrically connected (soldered/crimped) to point 406 at tip of tube 407.

401 is other extreme end of this wire 408.

Now if current is passed from 402 to 404 to 405 to 406 to 403, then the portion 404 to 405 will heat up, causing tip of the tube to heat up (Mode 1)

If current is passed from 402 to 404 to 401, then portion 404 to 401 (full body of the tube 407 except the tip) will heat up. In this mode tip will not heat up. (Mode 2)

If current is passed from 401 to 404 to 405 to 406 to 403, then entire Nicr wire 408 and hence the entire tube 407 will heat up. (Mode 3).

During piercing, computer is programmed to control current such that only the tip will heat up.

Once piercing is completed and tool 101 has received right side support 105, then heating is switched to Mode 2 or Mode 3 depending on the application. Mode 2 is preferred over Mode 3, as it will prevent over heating of support 105. But when knife is short and in vertical configuration without end support, Mode3 is preferred, as the bottom support material also must be cut by the knife.

Once piercing is complete and tool is latched to the support 105, the supports 105 & 106 can be moved on the YZ planes 102 & 103, along required path as per computer design, to cut the raw material to desired shape.

Once cutting of design is complete, tool 101 is moved away (retract) from support 105 and raw material 100.

Once fully retracted away from material, the tool can move to the next pierce point and continue the pierce +cut +retract cycle.

In another embodiment of the design, the wire 409 can also be a resistance heating wire, optionally thicker compared to the tip wire (404 to 405). In this method also, the tool can be controlled in modes 1,2 & 3 as explained earlier. This has added advantage that during mode2 & mode 3, wire 409 will also act as an active heating element, thus resulting in more efficient heating and cutting.

FIG. 2 shows an optional latching mechanism to accommodate any small deflection 206. The latching mechanism consists of a hinge 203 and flap 204, capable of rotating along axis 205 to lift the deflected beam to make it straight.

FIG. 3 shows the support 105 in more detail. It consists of a metallic plate 301, a spring or sponge material 302 and a fixed support 303.

The metallic plate 301 will absorb any heat at the tip of the tool.

The spring absorbs extra extension of the tool, to ensure 100% contact support, without buckling the tool.

A roller 108 fixed to the support 106 is proposed as shown in FIG. 1. This roller will provide guiding support to the tool 101, particularly when tool 101 is in fully retracted position. This roller will also prevent beam deflection and ensure orthogonal piercing of the tool into the raw material.

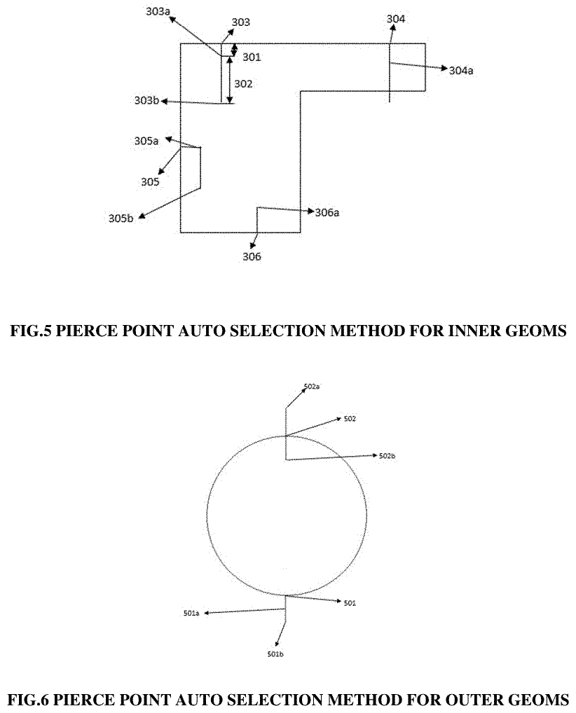

FIGS. 5 and 6 illustrates need for automatic method for choosing the pierce point. In spite of the precautions, a small beam deflection can happen. Referring to FIG. 5 showing an inner geometry, point 303 on the geometry should be chosen as pierce point instead of 304, 305 or 306, as these pierce points can result in the deflected beam/tool cutting the desired raw material.

FIG. 6 shows an outer geometry, where piercing at bottom is preferred over piercing at top. FIGS. 5 & 6 illustrate the need for an intelligent automatic pierce point selection method. Such a method is proposed in this invention.

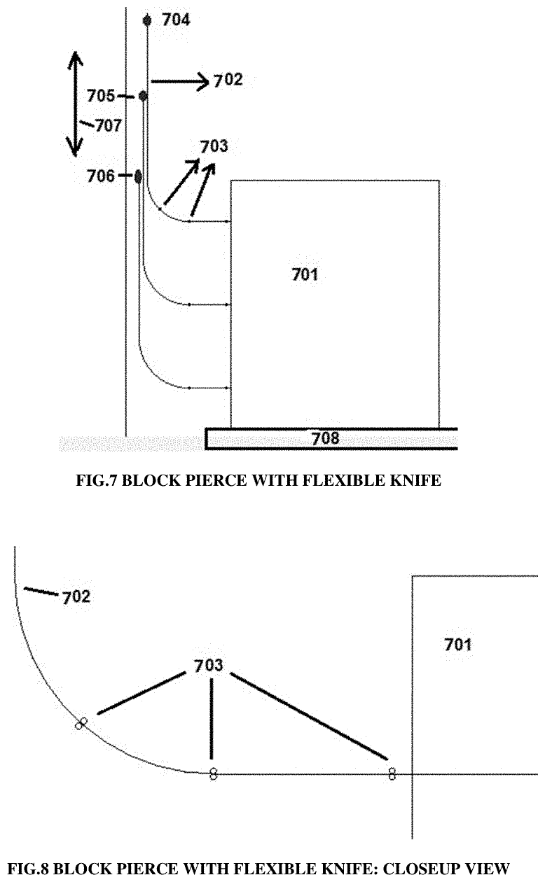

FIG. 7 shows a big block of foam raw material 701 resting on base 702.

The LHK 702 is guided by multiple rollers 703 as shown in FIG. 7.

Close up view of the rollers can be seen in FIG. 8.

The back end of the knifes (704, 705, 706 etc.) are fixed to a linear motion system 707.

The figures show multiple knifes. The proposed system is applicable for single or multiple knifes.

As the axis 707 moves down, the tip of the knife pierces into the foam block. The body of the knife suitably self bends as guided by the rollers and eventually becomes horizontal before entering/piercing the foam block.

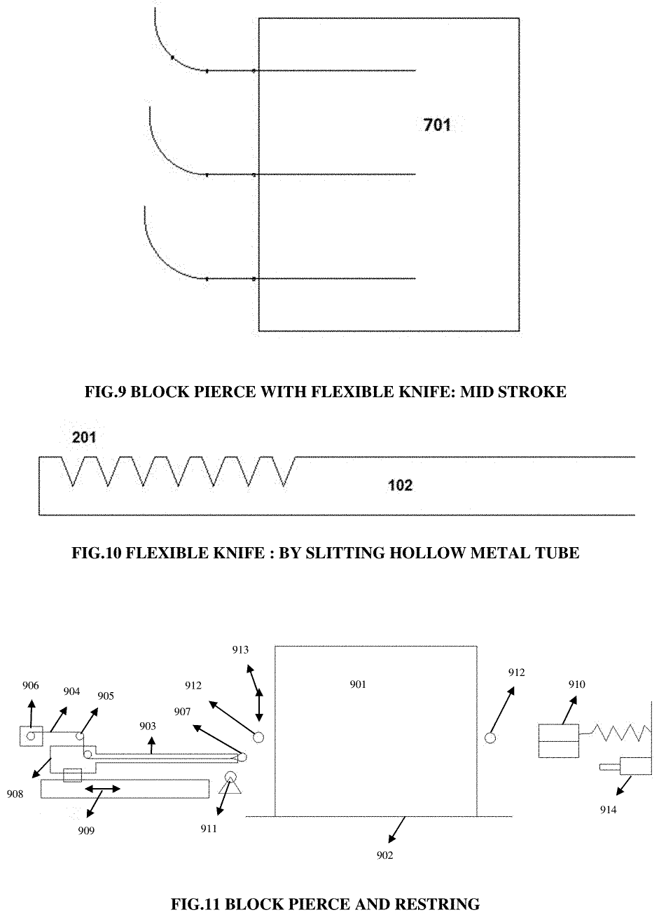

FIG. 9 shows the system state when the knife has pierced half way into the block.

As the axis 707 moves up, the knife will retract away from the block.

As explained in patent application 201741016238: METHOD OF CUTTING DESIGNS WITH INNER GEOMETRIES IN FOAM BLOCK: DOF: Jun. 21, 2017: During piercing, only the tip of the knife heats up, but the body of the knife is not hot. Thus, the portion of EPS in contact with the knife body is not melted and provides support to the body of the knife, preventing it from bending.

After piercing, the body of the knife can be heated to cut the block OR the knife can carry a bare NiCr wire to other end of the foam block as explained in patent application 201741021664.

The outer metal tube of the LHK is optionally slit (201) at periodic intervals to make it flexible, as shown in FIG10. This helps in easy bending of the knife and a sharper bending radius, resulting in a compact system.

Or the outer body of the Knife 702 can be made of any flexible material like a spring, so that it can bend easily, before entering the block.

The following paragraphs about FIG11, explain the automatic restringing method of heating wire, that is proposed in this invention.

FIG. 11 shows a big block of raw material 901 resting on base 902.

The piercing tool consists of a hollow metal tube (903) with embedded heating elements, such that only the tip of the tool will heat.

908 is the handle for the tool, which is mounted on linear motion axis 909.

Bare heating wire (904) is passing through the hollow tube 903.

The heating wire can be made of various alloys like NiChrome, kanthal etc.

One end of the NiCr wire is crimped to a small metal plate 907, typically a triangular plate as shown in FIG11. The metal plate can also be a simple KNOT in the string. This 907 will make sure one end of the NiCr wire is always outside the hollow tube 903.

Other end of the NiCr wire is coiled on shaft of a positioning motor 906.

905 is an optional roller, to prevent sharp bends in NiCr wire and to prevent wire from rubbing on sharp edges.

911 is a roller, to guide the tool 903 into the block, preventing the tool tip from sagging down because of self-weight.

At start of cut, tip of the tool 903 will start heating. Then the whole tool moves forward into the block, by axis 909.

As the tool 903 moves forward, the motor 906 unwinds the coiled wire 104.

The speeds of the axis motion 909 and motor 906 are automatically controlled, to keep the wire just taut at the right tension.

The tip of the tool melts and pierces the block and moves forward, carrying the end of the NiCr wire 907 along with it.

After the tool has fully pierced the block 901, the latching mechanism 910 on other side of the block catches the plate 907.

After this, the tool 903 starts retracting from the block, by axis 909.

During this retract motion, the motor 906 is stationery and does not rotate.

Once 903 has fully retracted, now only the bare wire 904 is inside the block.

This bare wire is now heated and further moved along the required tool path to cut as per design in computer by a CNC controller, like in a CNC HotWire machine.

Only the portion of the wire 904 which is inside the block is typically heated, with some margin on either side of the block.

At the end of cut, the string end plate 907 is released by 910. After this release, the motor 906 starts rotating, thus winding the NiCr wire on its shaft. This action pulls the wire 904 along with its end plate 907 out of the block.

The tool is then moved to the next pierce point by CNC and piercing and cutting operation continues as described above.

The string end plate 907 can optionally have a hole for easy latching.

In another embodiment, 910 can have a magnet to catch the string end plate 907.

In another embodiment, 906 can be a torsion spring, maintaining near constant pulling force on the string.

In another embodiment, after 907 is latched by 910, the rigid connection holding 910 to the main frame is released, upon which a spring connection exists between 910 and the main frame. This spring force helps in maintaining the wire taut during cutting. This rigid connection and its removal can be easily achieved by using actuators like solenoid (914), rc servo etc.

912 is an optional threaded or teethed rod or plate. This rod moves forward along axis 913, thus locking the string between any two of its teeth. This prevents the string from sliding up/down during cutting.

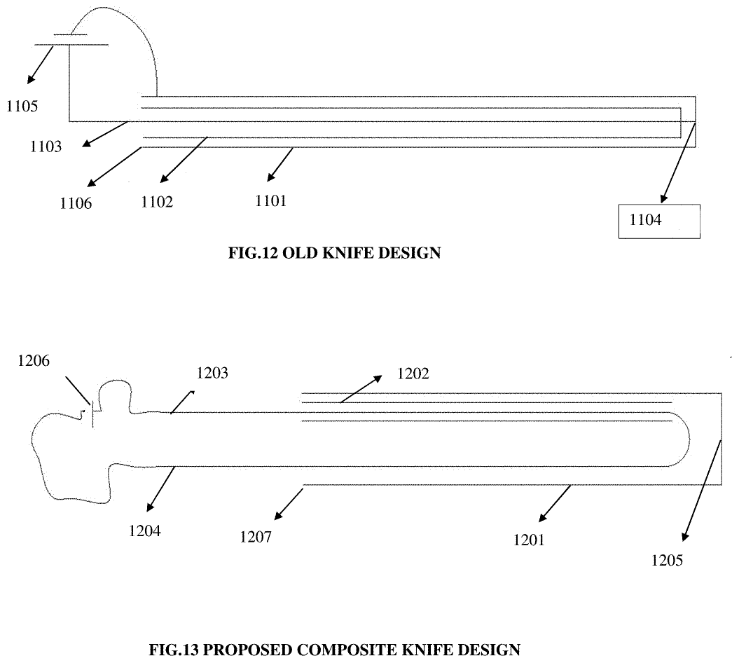

Following paragraphs explain the proposed composite looped knife design to increase knife life, thru FIG. 12 & FIG. 13.

FIG. 12 shows a typical hotknife in the market. 1101 is the outer metal tube. 1102 is an insulation sleeve. Heating element (NiCr etc.) wire 1103, goes thru the insulation sleeve 1102, reaches the tip 1104 of the knife, where it is crimped to the tip of the metal tube 1101.

Power supply 1105, is connected as shown in FIG. 11, passing current thru 1103, thus achieving heating.

This knife design has several problems

First problem is: tip becomes red hot (over heated compared to body), causing non-uniform cutting and excessive melting when piercing. This is due to the metal-metal contact (between NiCr and SS tube), resulting in high conductive heat transfer, compared to body of knife, where the insulating sleeve 1102 is present.

Another problem is that sometimes contact is lost between NiCr and SS tube at the tip, due to bulging of the overheated SS tube tip. Also, molten EPS sometimes enters the gap between NiCr and SS and solidifies, resulting in contact loss.

Also, sometimes, contact is lost between power supply 1105 and body of SS tube 1101.

FIG. 13 shows the proposed new design. It consists of outer metal tube 1201.

1203 is an insulated NiCr wire (heating element)

1202 is a sleeve (metal or fiber), passing thru 1201 and reaching the tip 1205 of the knife. 1202 is optional, but it helps the knife to be heated to higher temperatures without shorting.

1203 passes through inside of 1202, reaches the tip 1205 and returns to the other end 1207 of the tube 1201.

Power supply 1206 is connected between wire 1203 and 1204, thus heating the tube.

In this design, the tip is at almost the same temperature as body of the tube 101.

Also, in this looped wire design, no risk of loss of contact between NiCr and SS tube at tip 1205.

Since glass fiber sleeve is the insulating material around wire 1203, it tends to fuse with glass fiber sleeve of 1204, if they r very near to each other at high temperatures.

Here sleeve 1202, in between 1203 & 1204 prevents this fusing, thus extending life of the knife.

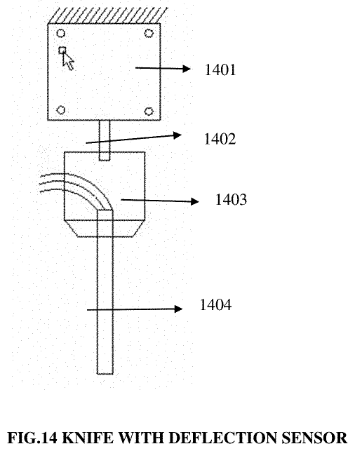

Referring now to FIG. 14, Hot-Knife cutting tools are commonly used to cut foam. But density & moisture content in foam varies, hence it is difficult to predict the cutting speed. Cutting tool slow can over melt the material and destroy fine features. Cutting too fast starts bending the knife, resulting in geometric inaccuracies.

A new design is proposed in this invention, where a deflection detection sensor 1401 is fixed on top of the knife 1404. The sensor is similar to a joystick used in PCs, capable of detecting deflection in 360 degrees. It is spring loaded, so when bending force disappears, it automatically returns to the central position. Two potentiometer shafts detect the degree of deflection. Any other position sensor can also be used. When the cutting knife 1404 experiences cutting forces, the shaft of the sensor will deflect and the sensor will measure the amount of deflection.

There is a heat sink mass 1403 between the output shaft of the sensor and the knife. This can be passively or actively cooled, preventing excess heat from transferring to the sensor, which can affect the sensor performance.

1403 also acts as a chuck to hold the knife 1404, such that 1404 can be easily replaced in case of any damage during cutting.

Similar sensor can also be mounted on top of a hot-scoop tool.

Both knife and scoop have slots for being held by an electromagnet, thus the CNC system can automatically pick-up the knife of desired length or scoop of desired width & depth etc.

1404 can be a regular knife or tip heating knife, convertible to body heating programmatically.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An automatic CNC wire cutting system 100, comprising of an intelligent knife 101, whose zone of heating is programmable, capable of piercing and starting profile cuts from middle of the block of material. The system having a spring loaded end support 105 to support the tip of the knife after block piercing.

2. The automatic system of claim 1, in which the knife 101 can have 3 different heating modes i.e. Tip only, Body Only, Tip & Body heating.

3. The automatic system of claim 1, in which the body of the knife 101 is made of a flexible material, such that the knife can be vertical when outside the block and become horizontal when piercing or cutting the block, resulting in a compact system.

4. The automatic system of claim 1, where the hotknife 101, carries forward a heating wire 904 when piercing the block and retracts back once the wire is held on at the end of piercing by a latching mechanism 910 at other side of the block. Then cutting is continued by the wire and wire also retracts back from the block pulled by actuator 906. 906 can optionally be a torsional spring also.

5. The heating wire is passed through hollow tube 903 of knife 101. The heating wire having a triangular retainer plate 907 with a latching hole or a knot at the end. The tension in the heating wire is maintained by the actuate 906, the latch 910 , the solenoid 914 and the spring behind the latch 910.

6. The automatic system of claim 1, with multiple hot knifes 101, with features as explained in claim 1,2,3,4,5, thus achieving simultaneous cutting of multiple objects.

7. The automatic system of claim 1, where in a laser beam is used for block piercing and subsequent cutting happens with a regular body heating knife Or by a wire carried forward to other end of the block by a thin hollow metal tube.

8. The automatic system of claim 1, where the knife 101 is vertical.

9. The automatic system of claim 1, where the knife 101 is a composite knife, with a metallic separation 1202 between wires 1203 & 1204, to prevent fusing of the fiber glass insulation sleeve, that can result in shorting of the wires.

10. The automatic system of claim 1, where the knife 101 is a composite knife with one of the wires 1203 or 1204 passing through a hollow metal tube 1202, thus ensuring metallic separation between the wires.

11. The automatic system of claim 1, where the knife 101 is fitted with spring loaded sensor 1401 to detect the deflection of the knife in 360 degrees any direction.

12. The automatic system of claim 1, with knife 101, fitted with sensor 1401, where in the system automatically adjusts federate or current such that the knife continues cutting without deflection.
